(19) United States
(12) Patent Application Publication
(10) Pub. No.: US 2020/0157698 A1
(43) Pub. Date: May 21, 2020

(54) METHOD OF MANUFACTURING MOLDED PRODUCT AND RADIATOR GRILLE USING THE SAME

(71) Applicants: Hyundai Motor Company, Seoul (KR); Kia Motors Corporation, Seoul (KR); SAM SHIN CHEMICAL CO., LTD., Ansan-si (KR)

(72) Inventors: Jin Young YOON, Gimpo-si (KR); Hyun Kyung KIM, Hwaseong-si (KR); Dong Eun CHA, Hwaseong-si (KR); Seung Hyeok CHANG, Suwon-si (KR); Ki Hong LEE, Seoul (KR); Hae Chang LEE, Ansan-si (KR); Sun Young PARK, Siheung-si (KR); Jun Hee CHO, Siheung-si (KR)

(73) Assignees: Hyundai Motor Company, Seoul (KR); Kia Motors Corporation, Seoul (KR); SAM SHIN CHEMICAL CO., LTD., Ansan-si (KR)

(21) Appl. No.: 16/366,989

(22) Filed: Mar. 27, 2019

(30) Foreign Application Priority Data
Nov. 19, 2018 (KR) 10-2018-0142965

(51) Int. Cl. C25D 5/02; B60R 19/52; B29C 45/00

(52) U.S. Cl. CPC C25D 5/022; B60R 19/52; B29C 2045/0079; B60R 2019/525; B29C 45/0053

(57) ABSTRACT

A method of manufacturing a molded product includes: performing molding for forming a product; performing insulation for coating an insulation material on a plating-unnecessary region of the product, excluding a plating-necessary region of the product, after mounting the product on a masking jig for plating formed to cover the plating-necessary region of the product and to expose the plating-unnecessary region of the product; and performing plating for forming a plating layer on the plating-necessary region, excluding the plating-unnecessary region coated with the insulation material, by electroplating the product coated with the insulation material.

### CROSS-REFERENCE TO RELATED APPLICATION

The present application claims priority to Korean Patent Application No. 10-2018-0142965, filed on Nov. 19, 2018, the entire contents of which is incorporated herein for all purposes by this reference.

### BACKGROUND OF THE INVENTION

### Field of the Invention

The present invention relates to a method of manufacturing a molded product, which is capable of preventing an increase in manufacturing costs caused by plating of a plating-unnecessary region of a molded product in an electroplating process, and a radiator grille using the same.

### Description of Related Art

In general, a vehicle is provided with a radiator, which is disposed in the space between the upper end portion of the bumper and the engine hood, that is, at the front side of the engine compartment, and which includes: a core having a large heat dissipation area to cool high-temperature coolant. The radiator is configured to forcibly feed the high-temperature coolant that has passed through the water jacket surrounding the engine and thus to dissipate the thermal energy from the high-temperature coolant to the air.

Furthermore, a radiator grille is mounted in front of the radiator to guide the flow of external air ahead of the vehicle, which is generated when the vehicle travels, that is, traveling wind, to the core of the radiator.

The radiator grille may be classified into a separated type, which is separately mounted between the bumper and the engine hood, and an integrated type, which is formed integrally with the engine hood, depending on the type of vehicle. The radiator grille is typically plated with chromium to realize a luxurious appearance.

However, when the radiator grille is plated, plating is also performed on a plating-unnecessary region due to the characteristics of electroplating, leading to an increase in plating material costs.

According to a conventional method of manufacturing a radiator grille, ABS resin is injection molded into a radiator grille having a designed shape, a pretreatment process (including a surface-cleaning process and an etching process for increasing adhesion) for chromium plating is performed on the surface of the radiator grille formed through the injection molding, the radiator grille that has undergone the pretreatment process is immersed in a chromium plating bath, and the entire surface of the radiator grille is plated with chromium.

However, because the entire surface of the radiator grille is immersed in the chromium plating bath and is plated with chromium, even a plating-unnecessary region is also plated, thus incurring an increase in manufacturing costs.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of manufacturing a molded product, which is configured for preventing an increase in manufacturing costs caused by plating of a plating-unnecessary region of a molded product in an electroplating process, and a radiator grille using the same.

In accordance with an aspect of the present invention, the above and other objects may be accomplished by the provision of a method of manufacturing a molded product, the method including performing molding for forming a product, performing insulation for coating an insulation material on a plating-unnecessary region of the product, excluding a plating-necessary region of the product, after mounting the product on a masking jig for plating formed to cover the plating-necessary region of the product and to expose the plating-unnecessary region of the product, and performing plating for forming a plating layer on the plating-necessary region, excluding the plating-unnecessary region coated with the insulation material, by electroplating the product coated with the insulation material.

In the performing the molding, a radiator grille including a frame portion having an open center portion and a plurality of grille portions, each having opposite end portions connected to the frame portion while extending across the open center portion of the frame portion, may be formed.

Plating passage holes may be formed in the opposite end portions of each of the grille portions that are connected to the frame portion. The plating passage holes may cause the front surface of the radiator grille and the rear surface of the radiator grille to communicate with each other therethrough.

The masking jig for plating includes: a front masking jig, disposed on the front surface of the radiator grille to cover the frame portion and the grille portions, and a rear masking jig, disposed on the rear surface of the radiator grille to cover the frame portion and the plating passage holes.

In the performing the molding, the front surface of the radiator grille may be formed to have recesses formed in both sides of the plating-necessary region of each of the grille portions.

In the performing the molding, the radiator grille may be formed to have through-holes formed in the frame portion. The through-holes may penetrate the front surface and the rear surface of the radiator grille.

The performing the plating includes: performing design for coating a design color on the product by mounting the product on a masking jig for coloring formed to expose a region of the product required for a product design.

In accordance with another aspect of the present invention, there is provided a radiator grille manufactured by the above-described method of manufacturing a molded product, the radiator grille including a frame portion having an open center portion while forming a border of the radiator grille and including a front plated surface and a rear plated surface, and a grille portion extending across the open center portion of the frame portion and including plating passage holes, which are formed in opposite end portions thereof that are connected to the frame portion and which penetrate the grille portion in a forward-and-backward direction of the grille portion, and a front plated surface. The plated region of the front plated surface of the frame portion and the plated region of the front plated surface of the grille portion may be spaced from each other so as not to be connected to each other. The plated region of the front plated surface of the grille portion may be connected to the plated region of the rear plated surface of the frame portion through the plating passage holes formed in the grille portion.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart showing a method of manufacturing a molded product according to an exemplary embodiment of the present invention;

FIG. 2 is a view showing the front surface of a radiator grille manufactured using the method of manufacturing a molded product shown in FIG. 1;

FIG. 3 is a view showing the rear surface of the radiator grille manufactured using the method of manufacturing a molded product shown in FIG. 1;

FIG. 4 and FIG. 5 are views showing the radiator grille manufactured using the method of manufacturing a molded product shown in FIG. 1;

FIG. 6 and FIG. 7 are views showing a masking jig for plating according to an exemplary embodiment of the present invention; and

FIG. 8 is a view showing a grille portion of the radiator grille according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present invention, it will be understood that the present description is not intended to limit the invention(s) to those exemplary embodiments. On another hand, the invention(s) is/are intended to cover not only the exemplary embodiments of the present invention, but also various alternatives, modifications, equivalents and other embodiments, which may be included within the spirit and scope of the invention as defined by the appended claims.

Hereinafter, a method of manufacturing a molded product and a radiator grille using the same according to various embodiments of the present invention will be described below in detail with reference to the accompanying drawings.

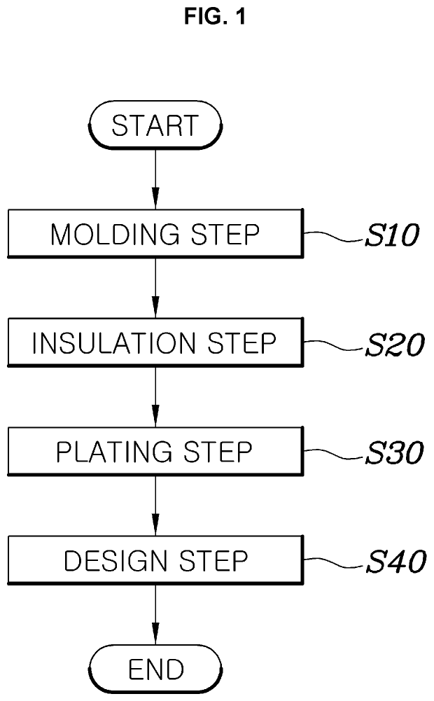

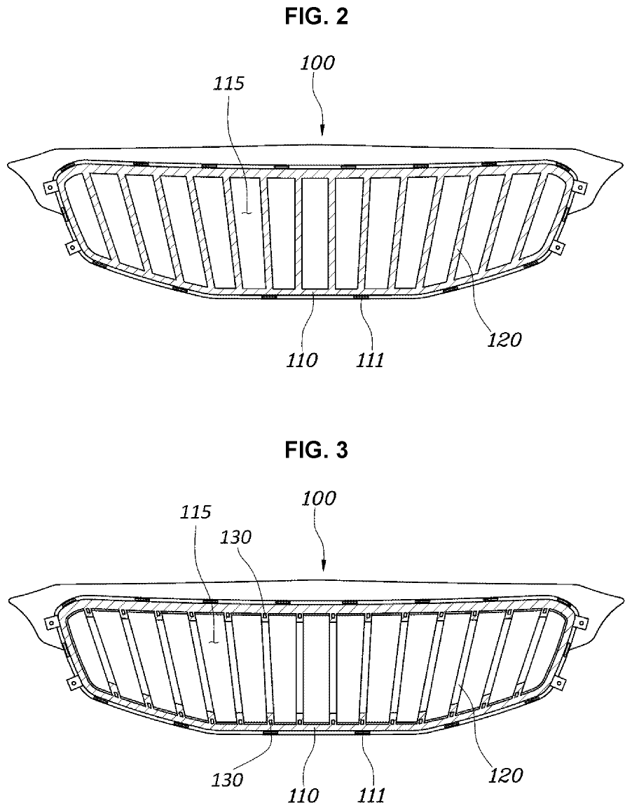

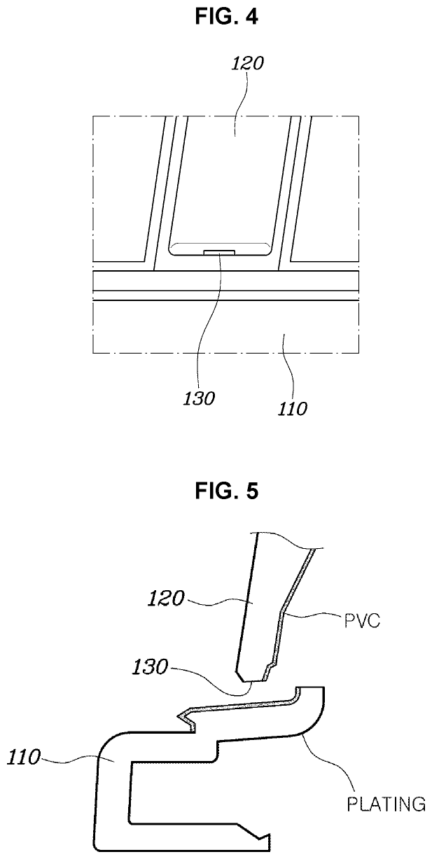

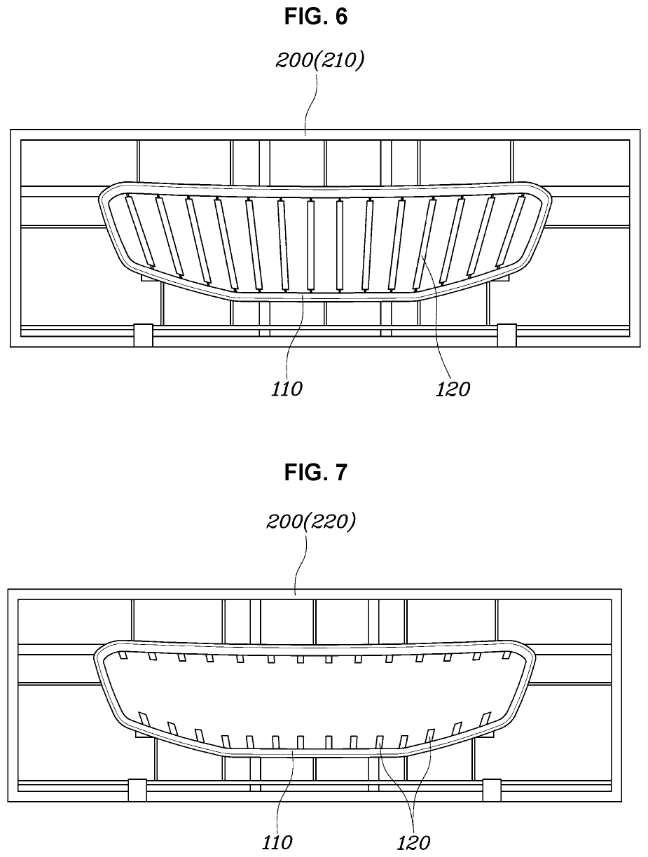

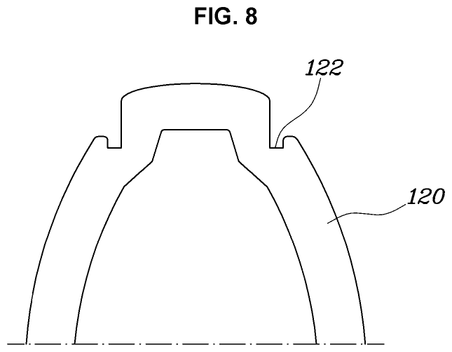

FIG. 1 is a flowchart showing a method of manufacturing a molded product according to an exemplary embodiment of the present invention, FIG. 2 is a view showing the front surface of a radiator grille manufactured using the method of manufacturing a molded product shown in FIG. 1, FIG. 3 is a view showing the rear surface of the radiator grille manufactured using the method of manufacturing a molded product shown in FIG. 1, FIG. 4 and FIG. 5 are views showing the radiator grille manufactured using the method of manufacturing a molded product shown in FIG. 1, FIG. 6 and FIG. 7 are views showing a masking jig for plating according to an exemplary embodiment of the present invention, and FIG. 8 is a view showing a grille portion of the radiator grille according to an exemplary embodiment of the present invention.

As shown in FIG. 1, a method of manufacturing a molded product according to an exemplary embodiment of the present invention includes: a molding step S10 of forming a product, an insulation step S20 of mounting the product on a masking jig 200 for plating, which is formed to cover a plating-necessary region of the product and to expose a plating-unnecessary region of the product, and coating an insulation material on the plating-unnecessary region excluding the plating-necessary region, and a plating step S30 of electroplating the product coated with the insulation material to form a plating layer on the plating-necessary region, excluding the plating-unnecessary region.

The method may further include, after the plating step S30, a design step S40 of mounting the product on a masking jig for coloring, which is formed to expose a region of the product required for a product design, and coating a design color on the exposed region of the product.

In the molding step S10, a product is injection molded using ABS-based resin. Here, the molded product may be a radiator grille 100. The radiator grille 100, as shown in FIG. 2 and FIG. 3, includes: a frame portion 110, which has an open center portion 115, and a plurality of grille portions 120, each of which has two opposite end portions connected to the frame portion 110 while extending across the open center portion of the frame portion 110. The radiator grille 100, which is a product formed through injection molding, may undergo a pretreatment process, which includes: a cleaning process for cleaning the surface thereof to facilitate painting and an etching process for increasing adhesion.

Furthermore, in the molding step S10, as shown in FIG. 4 and FIG. 5, the radiator grille 100 may be formed such that plating passage holes 130 are formed in two opposite end portions of each of the grille portions 120 that are connected to the frame portion 110. The front surface of the radiator grille 100 and the rear surface thereof communicate with each other through the plating passage holes 130. Since the front surface of the radiator grille 100 and the rear surface thereof communicate with each other through the plating passage holes 130, when plating is performed, a plated region of the front surface thereof and a plated region of the rear surface thereof may be connected to each other through the plating passage holes 130. That is, due to the plating passage holes 130 formed in two opposite end portions of each of the grille portions 120, which are connected to the frame portion 110, when plating is performed, the boundary lines between the frame portion 110 and the grille portions 120 becomes apparent, and the appearance of the radiator grille 100 is improved by the non-plated region on the connection portions between the frame portion 110 and the grille portions 120. Furthermore, the radiator grille 100 is provided at the rear surface thereof with a contact for applying an electrode to the plated region to improve the plating quality.

Subsequently, the radiator grille 100, which is formed to include the frame portion 110 and the grille portions 120 through the molding step S10, undergoes the insulation step S20. The insulation step S20 is performed such that the product is mounted on the masking jig 200 for plating, which is formed to cover a plating-necessary region of the product and to expose a plating-unnecessary region of the product, and an insulation material is coated on the product. That is, when the radiator grille 100, which is the molded product, is mounted on the masking jig 200 for plating, a plating-necessary region of the radiator grille is covered so as not to be exposed by the masking jig 200, and a plating-unnecessary region thereof is exposed. Therefore, when an insulation material, such as polyvinyl chloride (PVC) paint, is coated on the radiator grille 100, a plating-unnecessary region of the radiator grille 100 is coated with the PVC paint, and a plating-necessary region thereof is not coated with the PVC paint. Since the PVC paint has an electrically non-conductive property, the region coated with the PVC paint is not plated in the electroplating process.

Subsequently, in the plating step S30, the product coated with an insulation material undergoes electroplating. Therefore, a plating layer is formed on a plating-necessary region of the product, excluding a plating-unnecessary region thereof, which is coated with the insulation material. That is, only a plating-necessary region of the radiator grille 100, which is the molded product, is plated, and a plating-unnecessary region thereof is not plated. When electroplating is performed such that the radiator grille 100, which is the molded product, is immersed in a plating bath and is plated with a plating material such as chromium, the region of the radiator grille 100 which is coated with the PVC paint is not plated, minimizing the amount of plating material used to plate the radiator grille 100 and consequently reducing manufacturing costs.

In the radiator grille 100 that has undergone the plating step S30, the plated region on the front surface thereof and the plated region on the rear surface thereof are connected to each other through the plating passage holes 130. Therefore, a contact for applying an electrode to the plated region may be disposed on the rear surface of the radiator grille 100. Furthermore, since the front surface of the radiator grille 100 and the rear surface thereof are electrically connected to each other through the plating passage holes 130, electric uniformity and conductivity are improved, and accordingly the plating quality is improved.

After the plating step S30, the design step S40 is performed such that a design color is coated on the radiator grille 100, by which the apparent color of the radiator grille 100 is determined. In the design step S40, a masking jig for coloring, which is formed to expose a region of the product required for a product design, may be used. In the state in which the front surface of the radiator grille 100 is supported by the masking jig for coloring, a design color may be coated on the radiator grille 100. The design step S40 may be selectively performed after the molding step S10, the insulation step S20 and the plating step S30.

Described in greater detail, the masking jig 200 for plating used in the insulation step S20, as shown in FIG. 6 and FIG. 7, includes: a front masking jig 210, which is disposed on the front surface of the radiator grille 100 to cover the frame portion 110 and the grille portions 120, and a rear masking jig 220, which is disposed on the rear surface of the radiator grille 100 to cover the frame portion 110 and the plating passage holes 130.

That is, the masking jig 200 for plating includes: the front masking jig 210, which corresponds to the front surface of the radiator grille 100, and the rear masking jig 220, which corresponds to the rear surface of the radiator grille 100. The region of the front surface of the radiator grille 100 which is to be plated and the region of the rear surface thereof which is to be plated are different from each other. Due to the front and rear masking jigs 210 and 220 of the masking jig 200 for plating, respectively, the regions of the front and rear surfaces of the radiator grille 100 that are to be plated are accurately determined.

As shown in FIG. 6, the front masking jig 210, which corresponds to the front surface of the radiator grille 100, is configured to cover the frame portion 110 and the grille portions 120 separately from each other. Therefore, when the plating process is performed, the plated region of the frame portion 110 and the plated region of the grille portions 120 are distinctly differentiated from each other, and thus the appearance of the radiator grille 100 is improved.

Furthermore, as shown in FIG. 7, the rear masking jig 220, which corresponds to the rear surface of the radiator grille 100, is configured to cover the frame portion 110 and the plating passage holes 130. Therefore, when the plating process is performed, the rear surface of each grille portion 120, which is a plating-unnecessary region, is not plated. Furthermore, since the front surface of the frame portion 110 and the rear surface thereof are connected to each other through the plating passage holes 130, electric uniformity and conductivity are improved, and accordingly the plating quality is improved.

As described above, the masking jig 200 for plating, which is divided into two parts to correspond to the front surface and the rear surface of the radiator grille 100, distinctly differentiate a plating-necessary region and a plating-unnecessary region in the front and rear surfaces of the radiator grille 100, preventing an increase in material costs caused by plating of a plating-unnecessary region.

As shown in FIG. 8, in the molding step S10, the front surface of the radiator grille 100 is formed such that recesses 122 are formed in both sides of a plating-necessary region of each grille portion 120 to prevent degradation of design when the plating process and the coating of design color are performed.

If the recesses 122 are not formed in the grille portions 120 in the front surface of the radiator grille 100, when PVC paint is coated on the radiator grille 100 in the insulation step S20, the PVC paint accumulates on both sides of a plating-necessary region of each grille portion 120. In the instant state, if the radiator grille 100 is plated and coated with a design color, a plating layer and a design color layer accumulate on both sides of the plated region of each grille portion 120, degrading the quality of the radiator grille 100.

Therefore, the recesses 122 are formed in both sides of a plating-necessary region of each grille portion 120 in the front surface of the radiator grille 100. Accordingly, when the radiator grille 100 is coated with PVC paint in the insulation step S20, the PVC paint is introduced into the recesses 122, preventing accumulation of the PVC paint on both sides of a plating-necessary region of each grille portion 120. In the state in which the PVC paint does not accumulate on both sides of a plating-necessary region of each grille portion 120, when the radiator grille 100 is plated and coated with a design color, it is possible to obtain an excellent design without unevenness caused by accumulation of PVC paint.

Furthermore, in the molding step S10, the radiator grille 100 may be formed to have through-holes 111, which are formed in the frame portion 110 to penetrate the front surface and the rear surface of the radiator grille 100. The through-holes 111 are formed to provide paths for connecting a plating-necessary region of the front surface of the radiator grille 100 and a plating-necessary region of the rear surface thereof with each other therethrough. Due to the through-holes 111 formed in the frame portion 110 to penetrate the front and rear surfaces of the radiator grille 100, a plating-necessary region of the front surface and a plating-necessary region of the rear surface are electrically connected to each other through the through-holes 111 as well as the plating passage holes 130. In the present manner, since a plating-necessary region of the front surface of the radiator grille 100 and a plating-necessary region of the rear surface thereof are further electrically connected to each other through the through-holes 111, electric uniformity and conductivity are further improved, and the plating quality is therefore further improved.

Alternatively, instead of forming the through-holes 111, the plating-necessary region of the frame portion 110 of the radiator grille 100 may extend in an outward direction thereof, and a plurality of recessed portions may be formed in the extending portion of the frame portion 110 to be concave in an inward direction from the edge portion of the extending portion. Thus, the plating-necessary region of the front surface of the radiator grille 100 and the plating-necessary region of the rear surface thereof are connected to each other through the recessed portions. Of course, it may be possible to connect the plating-necessary region of the front surface of the radiator grille 100 and the plating-necessary region of the rear surface thereof with each other by extending the plating-necessary region of the frame portion 110 of the radiator grille 100 in the outward direction without forming the recessed portions. However, unless the recessed portions are formed, the area of the plating-necessary region is increased. Therefore, it is desirable to form the recessed portions in the extending portion of the plating-necessary region so that the width of the frame portion 110 is reduced. With the present configuration, it is possible to connect the plating-necessary region of the front surface of the radiator grille 100 and the plating-necessary region of the rear surface thereof with each other without forming the through-holes 111.

A radiator grille 100 manufactured by the method of manufacturing a molded product according to an exemplary embodiment of the present invention includes: a frame portion 110, which has an open center portion 115 while forming a border of the radiator grille 100 and includes: a front plated surface and a rear plated surface, and a grille portion 120, which extends across the open center portion of the frame portion 110 and includes: plating passage holes 130 formed in two opposite end portions thereof that are connected to the frame portion 110, the plating passage holes 130 penetrating the grille portion in the forward-and-backward direction thereof, and a front plated surface. A plated region of the front plated surface of the frame portion 110 and a plated region of the front plated surface of the grille portion 120 are spaced from each other so as not to be connected to each other. The plated region of the front plated surface of the grille portion 120 may be connected to a plated region of the rear plated surface of the frame portion 110 through the plating passage holes 130 formed in the grille portion 120.

As described above, the radiator grille 100 includes: the frame portion 110, the front surface and the rear surface of which are plated, and the grille portion 120, only the front surface of which is plated. Furthermore, since a plating-necessary region of the front surface of the radiator grille 100 and a plating-necessary region of the rear surface thereof are connected to each other through the plating passage holes 130 formed in two opposite end portions of the grille portion 120, when the plating process is performed, electric uniformity is secured, and the plating quality is therefore improved.

Furthermore, since a plating-unnecessary region of the radiator grille 100 is not plated, electricity consumption is reduced due to a reduction in the area to be plated, waste water generated by plating is reduced due to a reduction in the use of a plating material, and consequently manufacturing costs are reduced.

As is apparent from the above description, according to a method of manufacturing a molded product and a radiator grille using the same of the present invention, it is possible to prevent an increase in manufacturing costs caused by plating of a plating-unnecessary region of the molded product in an electroplating process.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a molded product, the method comprising:
performing molding for forming the molded product;
performing insulation for coating an insulation material on a plating-unnecessary region of the molded product, excluding a plating-necessary region of the molded product, after mounting the molded product on a first masking jig for plating formed to cover the plating-necessary region of the molded product and to expose the plating-unnecessary region of the molded product; and
performing plating for forming a plating layer on the plating-necessary region, excluding the plating-unnecessary region coated with the insulation material, by electroplating the molded product coated with the insulation material.

2. The method of claim 1, wherein, in the performing the molding, the molded product includes a radiator grille having a frame portion having an open center portion and a plurality of grille portions, each having first and second end portions connected to the frame portion while extending across the open center portion of the frame portion.

3. The method of claim 2, wherein at least a plating passage hole is formed in at least one of the grille portions that is connected to the frame portion, the at least one plating passage holes causing a front surface of the radiator grille and a rear surface of the radiator grille to fluidically-communicate with each other through the at least one plating passage hole.

4. The method of claim 2, wherein plating passage holes are formed in first and second end portions of each of the grille portions that are connected to the frame portion, the plating passage holes causing a front surface of the radiator grille and a rear surface of the radiator grille to fluidically-communicate with each other through the plating passage holes.

5. The method of claim 3, wherein the first masking jig for plating includes:
a front masking jig, mounted on the front surface of the radiator grille to cover the frame portion and the grille portions, and
a rear masking jig, mounted on the rear surface of the radiator grille to cover the frame portion and the at least one plating passage hole.

6. The method of claim 2, wherein, in the performing the molding, the front surface of the radiator grille has recesses formed in a first side and a second side of a plating-necessary region of each of the grille portions.

7. The method of claim 2, wherein, in the performing the molding, the radiator grille has through-holes formed in the frame portion, the through-holes penetrating a front surface and a rear surface of the radiator grille.

8. The method of claim 1, wherein the performing the plating includes:
performing design for coating a design color on the molded product by mounting the molded product on a second masking jig for coloring, which is formed to expose a region of the molded product required for a molded product design.

9. A radiator grille manufactured by the method of manufacturing the molded product of claim 1, the radiator grille comprising:
a frame portion having an open center portion and forming a border of the radiator grille, wherein the frame portion includes:
a front plated surface; and
a rear plated surface; and
a grille portion extending across the open center portion of the frame portion,
wherein the grille portion includes:
at least one plating passage hole formed in of the grille portion, the at least one plating passage hole penetrating the grille portion in a forward-and-backward direction of the grille portion; and
a front plated surface,
wherein a plated region of the front plated surface of the frame portion and a plated region of the front plated surface of the grille portion are spaced from each other so as not to be connected to each other, and
wherein the plated region of the front plated surface of the grille portion is connected to a plated region of the rear plated surface of the frame portion through the at least one plating passage hole formed in the grille portion.

10. The radiator grille of claim 9, the at least one plating passage hole includes first and second plating passage holes formed in first and second end portions of the grille portion, which are connected to the frame portion, the first and second plating passage holes penetrating the grille portion in the forward-and-backward direction of the grille portion.
